(19) United States
(12) Patent Application Publication
(10) Pub. No.: US 2014/0333074 A1
(43) Pub. Date: Nov. 13, 2014

(54) Compression Latch

(71) Applicant: Weston Body Hardware Limited, Worcestershire (GB)

(72) Inventors: Martin Wollacott, Worcestershire (GB); Michael Leslie, Worcestershire (GB)

(73) Assignee: Weston Body Hardware Limited, Worcestershire (GB)

(21) Appl. No.: 14/270,262

(22) Filed: May 5, 2014

(30) Foreign Application Priority Data
May 8, 2013 (GB) GB1308273.0

(51) Int. Cl. E05C 17/00

(52) U.S. Cl. CPC E05C 17/00
USPC 292/202

(57) ABSTRACT

A compression latch for a closure, the latch including a housing, a latch member and an input shaft configured to drive the latch. The latch member is pivotably connected to the housing at a latch member pivot point. The latch member includes a latch arm and a striker. The latch arm first end is connected to the input shaft at the latch member pivot point, such that the latch member is pivotable about the latch member pivot point between an open position and a closed position upon operation of the input shaft. The striker is pivotably connected to the latch arm second end at a first striker pivot point. The latch arm is configured to move the striker with respect to the housing in a first arc and the linkage is configured to pivot the striker with respect to the housing about the latch arm in a second arc.

### CROSS-REFERENCE TO RELATED APPLICATIONS

This application claims priority to Great Britain Application No. GB1308273.0 filed on May 8, 2013, the entire contents of which are hereby incorporated by reference herein.

### TECHNICAL FIELD

The present invention relates to a compression latch for a closure.

### BACKGROUND OF THE INVENTION

It is known to use compression latches in a variety of applications, for example when force is required to hold a closure in place, or when sealing of a closure (e.g. a door, window or access panel of a vehicle or an item of construction plant) is needed. Compression latches are often of the type known as a “trigger” latch, having a trigger latch member in the handle that is used to retain the handle in a closed position.

Such latches often incorporate a pivotable latch member held against a closure surround by a latch mechanism. The latch member is configured to be pivoted to a closed position by a handle. The latch mechanism holds the latch member in the closed position, so that pressure is applied by the latch to a closure to keep it shut and/or seal it. Upon release of the latch mechanism, the latch member is pivoted open by a handle or a resilient biasing device, enabling the closure to be opened. Compression latches are typically mounted in an aperture cut from the material of the closure.

There can be difficulties with existing compression latches of this type. The latch member must clear the closure surround when the latch is in a fully open position, so that it does not prevent the closure from being fully opened. The latch member moves in an arc towards the closed position as it is pivoted by the handle, so that there is lateral movement and therefore friction between the latch member and the closure surround. The latch member can move across the surface of the closure surround as it reaches the closed position, causing damage to the closure surround and increasing the amount of lateral force that must be applied to move the latch member to the closed position.

Decreasing the length of the latch member would decrease lateral movement of the latch member in relation to the closure surround, as the arc, and thus the lateral component of the arc, would be smaller. However, decreasing the length of the latch member is not always possible, as the latch member must reach the closure surround. In addition, decreasing the length of the latch member can lead to the latch being positioned closer to the closure surround to ensure that the latch member reaches the closure surround, and so increases the likelihood of the latch member interfering with the closure surround when the latch is in a fully open position. This could therefore prevent the closure from being fully opened.

The present invention seeks to overcome, or at least mitigate, the problems of the prior art.

### SUMMARY OF THE INVENTION

According to the present invention there is provided a compression latch for a closure, the latch comprising a housing, a latch member and an input shaft configured to drive the latch. The latch member is pivotably connected to the housing at a latch member pivot point. The latch member comprises a latch arm having a first end and a second end, and a striker. The latch arm first end is connected to the input shaft at the latch member pivot point, such that the latch member is pivotable about the latch member pivot point between an open position and a closed position upon operation of the input shaft. The striker is pivotably connected to the latch arm second end at a first striker pivot point. The latch further comprises a linkage configured to control pivoting of the striker with respect to the latch arm. The latch arm is configured to move the striker with respect to the housing about the latch member pivot point in a first arc and the linkage is configured to pivot the striker with respect to the housing about the latch arm in a second arc, the second arc being smaller than the first arc.

The latch is configured such that in use, lateral movement of the striker with respect to the housing is minimised as the latch member nears the closed position.

The striker being pivotable in relation to the latch arm allows the arc of the striker to be varied as the latch member moves between an open position and the closed position. The arc of the striker as the latch member reaches the closed position can thus advantageously be adjusted to reduce lateral movement of the striker with respect to a closure surround, yet the striker can be moved out of the way of the closure surround when in the open position, so it does not interfere with closure.

The linkage may pivotably connect the striker to the housing.

The linkage may comprise a link having first and second ends, wherein the link first end may be pivotably connected to the housing at a link pivot point and the link second end may be pivotably connected to the striker at a second striker pivot point.

The striker may have a first end and a second end, wherein the striker second end may be configured for contact with a closure surround, and wherein the second striker pivot point may be proximal the striker first end.

The first striker pivot point may be between the striker second end and the second striker pivot point.

The link pivot point may be remote from the latch member pivot point.

The latch may further comprise a resilient biasing arrangement, and the latch member may be resiliently biased towards an open position.

The latch may further comprise a handle pivotably connected to an outboard side of the housing and configured to operate the input shaft.

The handle may be connected to the latch member pivot point.

The handle may include a trigger latch member configured to be retained in the housing.

The latch may further comprise a lock. The latch may be integral to the handle.

The input shaft may extend between inboard and outboard sides of housing.

The housing may be of plastics material.

The housing may comprise a seal configured to seal the inboard side of the housing from the outboard side of the housing.

The striker may be adjustable.

The striker may be on an inboard side of the housing.

The handle may be arranged to pivot in a generally inboard direction to move the latch member towards the closed position.

The striker may move in a generally outboard direction as the latch member moves towards the closed position.

### BRIEF DESCRIPTION OF THE DRAWINGS

A compression latch will now be described in detail by way of example and with reference to the accompanying drawings in which:

FIG. 1 is a perspective view of a compression latch according to an embodiment of the present invention in a closed position;

FIG. 2 is a further perspective view of the compression latch of FIG. 1 in a closed position;

FIG. 3 is a side view of the compression latch of FIGS. 1 and 2 in a fully open position;

FIG. 4 is a side view of the compression latch of FIGS. 1 to 3 in a partially open position; and

FIG. 5 is a side view of the compression latch of FIGS. 1 to 4 in a closed position.

### DETAILED DESCRIPTION OF EMBODIMENT(S)

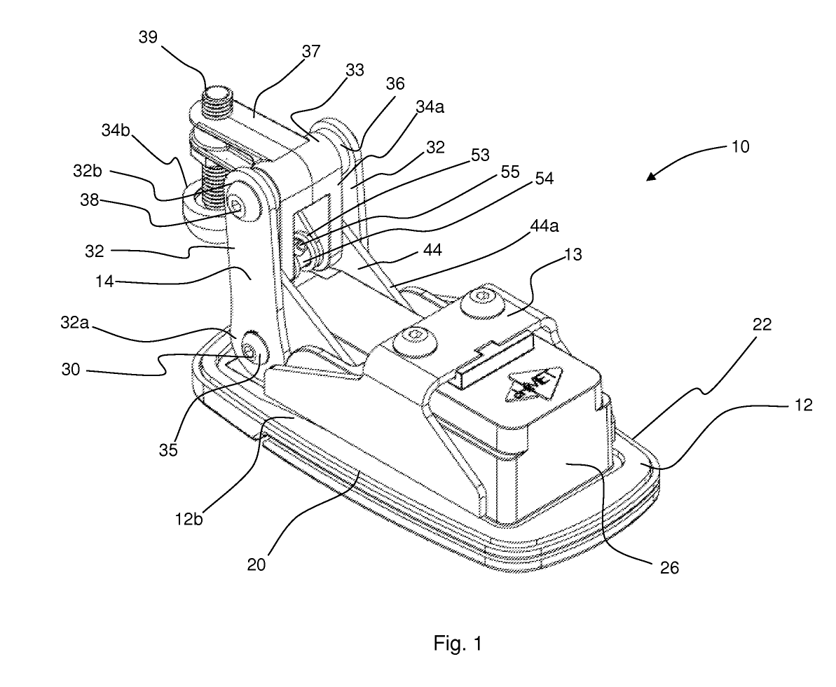

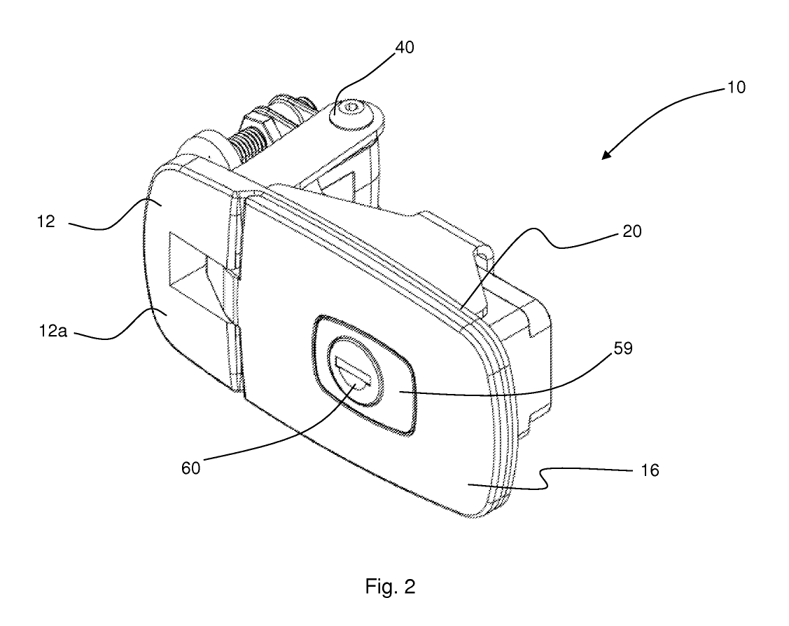

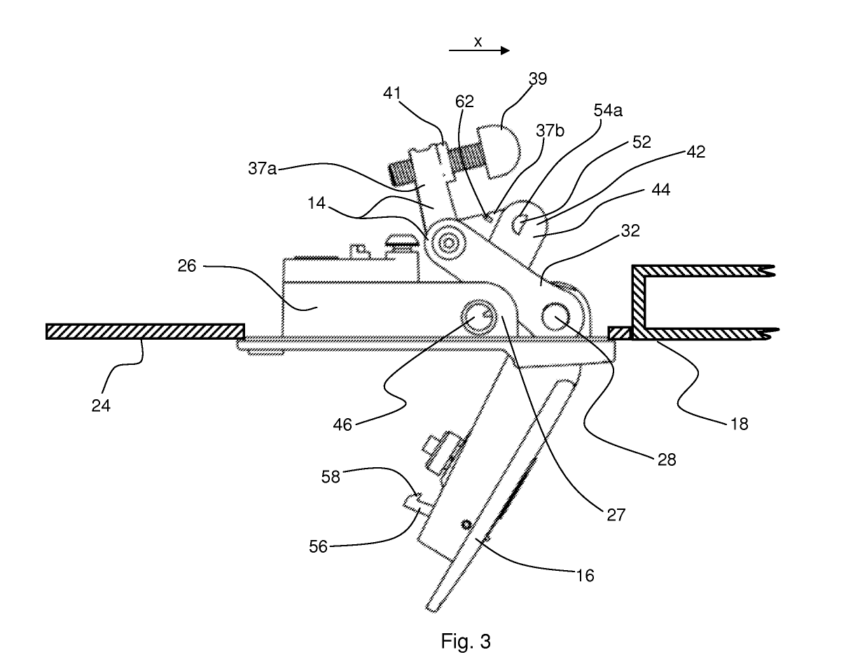

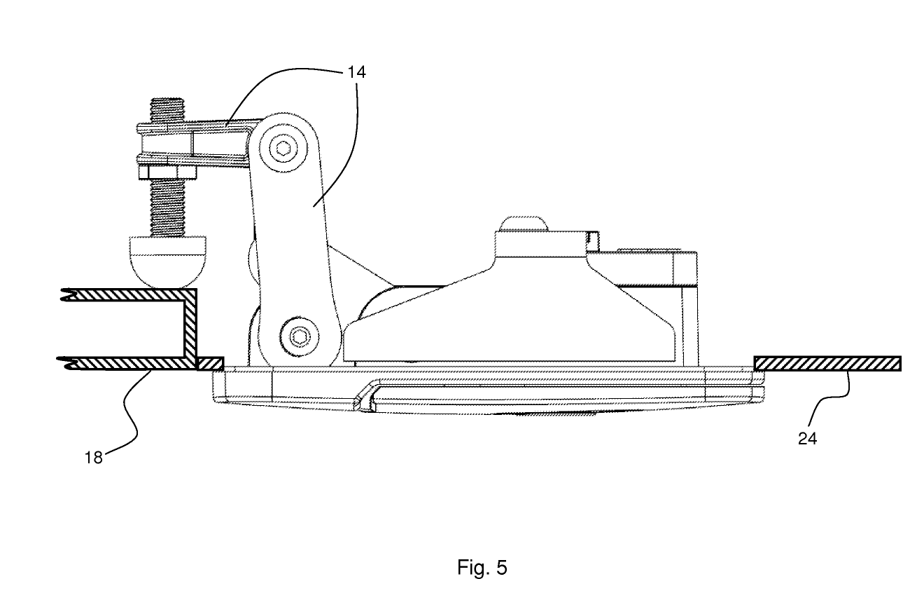

Referring to FIGS. 1 to 5, a trigger compression latch according to an embodiment of the present invention is generally indicated at 10. The latch 10 has a housing 12, a latch member 14 and a handle 16 configured to operate the latch member 14. The latch 10 is movable between a closed position, as shown in FIGS. 1 and 2, in which the latch member 14 is actuated to apply pressure to a closure surround 18 (see FIGS. 3 to 5), and a fully open position, wherein the latch member 14 is clear of the closure surround.

The housing 12 defines an outboard side 12a and an inboard side 12b, and has a main body 20 defining a plane. The housing 12 has a first edge 22 intended to be mounted proximal a free edge of a closure 24 (i.e. the edge over which the latch member 14 extends). The housing 12 comprises a seal (not shown) at the edge 22, allowing the housing 12 to be sealed against the closure 24. In addition, the inboard side 12b is substantially sealed from the outboard side 12a to inhibit the ingress of water through the latch 10.

The housing 12 is configured to fit an aperture in the closure 24 suitable for a standard compression trigger latch, such as the type used on vending machines, so can be retrofitted to existing closures. A bracket 13 is configured to hold the housing 12 in place on the closure 24.

The housing 12 defines at its outboard side 12a a handle recess (not shown) with walls 26 extending to the inboard side 12b of the housing 12. The handle recess is configured to receive at least part of the handle 16 when the latch 10 is in the closed position. The walls 26 extend beyond either side of the recess to form planar extensions 27.

The walls 26 define two co-axial circular apertures (not shown). A drive shaft 28, pivotably supported by the circular apertures in the walls 26, extends between the inboard 12b and outboard 12a sides of the housing to connect the handle 16 to the latch member 14. The drive shaft 28 forms a latch member pivot point 30, and acts as an input shaft 28 to the latch member 14.

The latch member 14 and the handle 16 are keyed to the shaft 28, so that the latch member 14 pivots as the handle 16 is pivoted between the closed position and an open position. In alternative embodiments, the drive shaft 28 may be of non-circular cross-section where the latch member 14 and the handle 16 are connected to the shaft 28, so that the latch member 14 pivots as the handle 16 is pivoted.

The latch member 14 comprises two opposing latch arms 32 and a striker 34. Each latch arm 32 has a first end 32a and a second end 32b. The first ends 32a are connected to either end of the drive shaft 28 at the latch member pivot point 30. Each first end 32a defines an aperture (not shown) through which the drive shaft 28 extends, and is retained on the drive shaft 28 by a fastener 35.

The striker 34 is substantially U-shaped and has a first end 34a and a second end 34b. In this embodiment, the striker 34 has an L-shaped first part 37 having a base 37a and a perpendicular arm 37b forming the striker first end 34a, and a bolt second part 39 forming the striker second end 34b. The striker base 37a has a circular aperture (not shown) and an integral threaded nut 41 configured to receive and retain the bolt 39. The bolt 39 extends substantially perpendicular to the base 37a and substantially parallel to the arm 37b, so that the striker 34 is U-shaped.

The bolt 39 can be adjusted in relation to the remainder of the striker 34 by screwing in or out of the nut 41, in order to adjust the latch 10 for different closures.

The striker first part 37 is pivotably connected to the latch arm 32 at the second ends 32b. The striker first part 37 has a striker shaft 36 extending from its corner 33, i.e. where the base 37a and the arm 37b meet. Each latch arm second end 32b defines a circular aperture (not shown) through which the striker shaft 36 extends, forming a first striker pivot point 38. The second ends 32b are attached to the striker shaft 36 by a fastener 40 such that the striker 34 is pivotable in relation to the latch arm 32.

The latch arms 32 are configured to move the striker 34 about the latch member pivot point 30 in a first arc, upon pivoting of the latch arms 32 between the closed and open positions by the handle 16. Movement in the arc includes a component of movement in a direction substantially parallel to a plane defined by the closure surround 18, indicated here as lateral movement x (e.g. as shown in FIG. 3).

The latch 10 further comprises a linkage 42 configured to control pivoting of the striker 34 with respect to the latch arm 32. The linkage 42 comprises in this embodiment two opposing links 44. The links 44 pivotably connect the striker 34 to the housing 12.

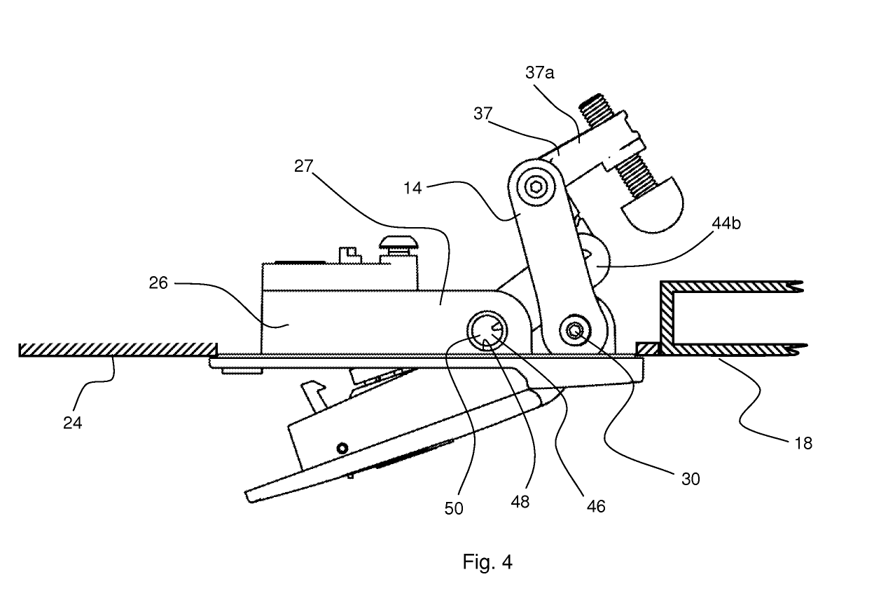

The links 44 have first 44a and second 44b ends. The link first ends 44a are pivotably connected to the housing 12 at a link pivot point 46 provided by circular apertures 48 defined by the extensions 27 (see FIG. 4). Fasteners 50 extend through apertures (not shown) in the link first ends 44a and the apertures 48 to provide a pivotable connection between the links 44 and the housing 12. The link pivot point 46 is in this embodiment remote from the latch member pivot point 30 in the direction x. The link pivot point 46 is in this embodiment between the latch member pivot point 30 and the free edge of the closure 24.

The link pivot point 46 being remote from the latch member pivot point 30 advantageously provides two separate points where the load of the latch member 14 is received by the housing 16, so that the latch member 14 load is shared. Sharing of the load decreases the strength requirement of the housing 16, thus decreasing the load requirement of the housing material. As described below, the housing 16 can thus in this embodiment be of a plastics material rather than metal, reducing cost.

The link second ends 44b are pivotably connected to the striker 34 at a second striker pivot point 52. In this embodiment, the second striker pivot point 52 is proximal a free end of the striker arm 37b. The second striker pivot point 52 includes a shaft 54 extending through the striker arm 37b, about which the striker 34 is pivotable. The shaft 54 has semi-circular ends 54a extending through corresponding apertures (not shown) in the link second ends 44b, so is keyed to the link second ends 44b. The relative positioning of the first 38 and second 52 striker pivot points is in this embodiment such that the first striker pivot point 38 is between the striker second end 34b and the second striker pivot point 52.

The latch 10 of this embodiment includes a resilient biasing arrangement 53 configured to bias the latch member 14 towards an open position. In this embodiment, the resilient biasing arrangement includes a torsion spring 53 extending around the shaft 54. The spring 53 acts between the striker 34 and the shaft 54 to bias the striker 34 towards an open position.

A first end (not shown) of the spring 53 is received by a notch 62 defined by the striker arm 37b. A second end (not shown) of the spring 53 is held in place on the shaft 54 by a pin 55, so that the spring 53 acts between the striker arm 37b and the shaft 54 to bias the striker 34 towards an open position.

In alternative embodiments (not shown), the resilient biasing arrangement may include a compression spring (not shown) acting between some other part of the latch member 14 and the shaft 54, and/or between the latch member 14 and the housing 12. In further alternative embodiments some other suitable biasing arrangement may be used, and/or the biasing arrangement may be configured to act on some other part of the latch 10, e.g. the handle 16.

The linkage 42 is configured to pivot the striker 34 in a second arc about the first striker pivot point 38. Due to the geometry and arrangement of the linkage 42 and the latch arms 32, the second arc is smaller than the first arc. As described above, movement in the arc includes a component of movement in a direction substantially parallel to a plane defined by the closure surround 18, indicated here as lateral movement x (e.g. as shown in FIG. 3).

The handle 16 of this embodiment includes a trigger latch 56. The trigger latch 56 includes a hook 58 resiliently biased towards a closed position, and configured to hook around a retaining part (not shown) of the housing 12 when the latch 10 is in the closed position so as to prevent movement of the handle 16 towards an open position. The handle 16 also includes a release mechanism 59, which is in this embodiment a push-button release mechanism. Pushing the release mechanism 59 results in pivoting of the hook 58 to an open position, so that the handle 16 can be moved to an open position. In this embodiment, due to the biasing arrangement 53, the handle 16 is automatically moved to an open position upon operation of the release mechanism 59.

The handle 16 further includes a lock 60 configured to selectively prevent operation of the release mechanism 59. In this embodiment the lock 60 is a barrel lock, though in other embodiments other suitable types of lock may be used. The lock 60 is in this embodiment integral to the push-button 59, though in alternative embodiments the lock 60 may be elsewhere in the handle 16 or the housing 12. The lock 60 allows the latch 10 to be secured in a closed position, as the latch member 14 cannot be operated without pivoting of the handle 16.

In an alternative embodiment the latch 10 may not comprise a lock.

In this embodiment, the housing 12 and the handle 16 are of a plastics material such as glass-filled nylon. In alternative embodiments, the housing 12 and the handle 16 are of a metal such as zinc or stainless steel, and may be cast, for example die-cast or investment cast. The release mechanism 59 is in this embodiment of metal, for example die-cast or investment cast zinc or stainless steel. In alternative embodiments, the release mechanism 59 may be of glass-filled nylon or some other suitable plastics material.

The latch member 14 is in this embodiment of metal such as zinc or stainless steel. The striker first part 37 in particular may be cast, for example die-cast or investment cast. The latch arm 32 and/or the linkage 42 may be of pressed steel or steel rod, and/or may be cast.

In use, the latch member 14 is moved, upon operation of the handle 16, from the fully open position to the closed position, e.g. as shown in FIGS. 3 to 5. As the latch member 14 is first moved from the fully open position, movement of the striker 34 is generally dictated by the latch arms 32, i.e. so that the striker 34 is moved substantially in the first arc about the latch member pivot point 30. As the latch member 14 continues to be moved towards the closed position, the linkage 42 starts to limit movement of the striker in the first arc, e.g. as shown in FIG. 4, and movement of the striker 34 is generally dictated by the linkage 42. The striker 34 is then moved substantially in the second arc.

Movement of the striker 34 is controlled by both the latch arms 32 and the linkage 42 throughout the striker's movement from fully open to closed position. However, in a first stage of movement from the fully open to the closed position, movement of the striker 34 is affected more by the latch arms 32 than by the linkage 42 due to the arrangement of the latch 10, so is described above as being generally dictated by the latch arms 32 so that the striker 34 is moved substantially in the first arc—i.e. in a direction closer to the first arc than to the second. In a second stage of movement from the fully open to the closed position, movement of the striker 34 is affected more by the linkage 42 than by the latch arms 32, so is described above as being generally dictated by the linkage 42 so that the striker 34 is moved substantially in the second arc—i.e. in a direction closer to the second arc than to the first.

As the second arc is smaller than the first arc, the lateral component x of the second arc is less than that of the first arc. As the striker 34 nears the closed position, movement of the striker 34 is being generally dictated by the linkage 42 as described above, so the striker 34 is moving in a smaller arc than would otherwise be the case. This advantageously leads to less lateral movement x of the striker 34 in relation to the closure surround 18 as the striker 34 reaches the closed position, thus decreasing friction between the striker 34 and the closure surround 18, and also the likelihood of damage to either component.

Upon opening of the latch 10, the latch member 14 returns to the open position in reverse to the sequence described above. As the striker 34 nears the fully open position, therefore, its movement is generally dictated by the latch arms 32, so that the striker 34 is moved substantially in the first arc. The increased lateral movement provided by movement in this arc ensures that the striker 34 is well out of the way of the closure surround, so that clearance is provided.

Advantageously, the latch allows the striker to approach the closure at a relatively steep angle, reducing lateral movement of the striker, whilst maintaining the distance between the striker and the handle/latch member pivot point, so that the closure surround can be reached by the striker and the latch mechanism is not interfered with by the striker or the latch member.

In alternative embodiments, the striker 34 may be a single integral component, and/or may be of some suitable shape other than a U-shape. Although shown in this embodiment as part of a trigger latch assembly, the latch 10 can also be used with other types of compression latches. The latch 10 may be arranged so as to provide over-centre motion of the latch member 14. The handle 16 may be connected to the housing 12 at a pivot point remote from the latch member pivot point 30, and/or may be connected to the latch member via a linkage.

1. A compression latch for a closure, the latch comprising:
a housing, a latch member and an input shaft configured to drive the latch, wherein:
the latch member is pivotably connected to the housing at a latch member pivot point;
the latch member comprises a latch arm having a first end and a second end, and a striker;
the latch arm first end is connected to the input shaft at the latch member pivot point, such that the latch member is pivotable about the latch member pivot point between an open position and a closed position upon operation of the input shaft; and
the striker is pivotably connected to the latch arm second end at a first striker pivot point;
the latch further comprising a linkage configured to control pivoting of the striker with respect to the latch arm;
wherein the latch arm is configured to move the striker with respect to the housing about the latch member pivot point in a first arc and the linkage is configured to pivot the striker with respect to the housing about the latch arm in a second arc, the second arc being smaller than the first arc, such that in use lateral movement of the striker with respect to the housing is minimised as the latch member nears the closed position.

2. A compression latch according to claim 1 wherein the linkage pivotably connects the striker to the housing.

3. A compression latch according to claim 1 wherein the linkage comprises a link having first and second ends, wherein the link first end is pivotably connected to the housing at a link pivot point and the link second end is pivotably connected to the striker at a second striker pivot point.

4. A compression latch according to claim 3 wherein the striker has a first end and a second end, wherein the striker second end is configured for contact with a closure surround, and wherein the second striker pivot point is proximal the striker first end.

5. A compression latch according to claim 4 wherein the first striker pivot point is between the striker second end and the second striker pivot point.

6. A compression latch according to claim 3 wherein the link pivot point is remote from the latch member pivot point.

7. A compression latch according to claim 1 further comprising a resilient biasing arrangement, wherein the latch member is resiliently biased towards an open position.

8. A compression latch according to claim 1 further comprising a handle pivotably connected to an outboard side of the housing and configured to operate the input shaft.

9. A compression latch according to claim 8 wherein the handle is connected to the latch member pivot point.

10. A compression latch according to claim 8 wherein the handle includes a trigger latch member configured to be retained in the housing.

11. A compression latch according to claim 1 further comprising a lock.

12. A compression latch according to claim 11 and further comprising a handle, wherein the lock is integral to the handle.

13. A compression latch according to claim 1 wherein the input shaft extends between inboard and outboard sides of housing.

14. A compression latch according to claim 1 wherein the housing is of plastics material.

15. A compression latch according to claim 1 wherein the housing comprises a seal configured to seal the inboard side of the housing from the outboard side of the housing.

16. A compression latch according to claim 1 wherein the striker is adjustable.

17. A compression latch according to claim 1 wherein the striker is on an inboard side of the housing.

18. A compression latch according to claim 8 wherein the handle is arranged to pivot in a generally inboard direction to move the latch member towards the closed position.

19. A compression latch according to claim 18 wherein the striker moves in a generally outboard direction as the latch member moves towards the closed position.
